(19) United States
(12) Patent Application Publication
(10) Pub. No.: US 2021/0379930 A1
(43) Pub. Date: Dec. 9, 2021

(54) Solid Tire Assembly

(71) Applicant: Terry Imig, Seward, NE (US)

(72) Inventor: Terry Imig, Seward, NE (US)

(21) Appl. No.: 16/892,721

(22) Filed: Jun. 4, 2020

(51) Int. Cl. B60C 7/08; B60C 7/10

(52) U.S. Cl. CPC B60C 7/08; B60C 7/10

(57) ABSTRACT

A solid tire assembly for eliminating flat tires on a vehicle includes a tire that is defined by a plurality of concentric rings. Each of the concentric rings is comprised of a resiliently compressible material to facilitate the tire to perform similar to an inflated tire. Each of the concentric rings is comprised of a plurality of bands. Moreover, intersections between each of the bands of each of the concentric rings are staggered with respect to each of the concentric rings to enhance structural integrity of the tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to solid tire devices and more particularly pertains to a new solid tire device for eliminating flat tires on a vehicle.

### Description of Related Art Including Information Disclosed Under 37 CFR 1.97 and 1.98

The prior art relates to solid tire devices including a non-pneumatic tire that includes a plurality of supporting walls that define spaces within the non-pneumatic tire. The prior art discloses a solid tire that includes a tread portion which releasably engages a sidewall portion. The prior art discloses a non-pneumatic tire that includes a plurality of spoke structures that are independent from each other to facilitate compression and expansion of the tire. The prior art discloses a non-pneumatic tire that includes a plurality of concentric rings being separated from each other via nested V-shaped supports. The prior art also discloses a non-pneumatic tire that includes a pair of curved halves that can attached together to form a tire.

### Brief Summary of the Invention

An embodiment of the disclosure meets the needs presented above by generally comprising a tire that is defined by a plurality of concentric rings. Each of the concentric rings is comprised of a resiliently compressible material to facilitate the tire to perform similar to an inflated tire. Each of the concentric rings is comprised of a plurality of bands. Moreover, intersections between each of the bands of each of the concentric rings are staggered with respect to each of the concentric rings to enhance structural integrity of the tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a solid tire assembly according to an embodiment of the disclosure.

FIG. 2 is a front view of an embodiment of the disclosure.

FIG. 3 is a right side view of an embodiment of the disclosure.

FIG. 4 is a cross sectional view taken alone line 4-4 of FIG. 2 of an embodiment of the disclosure.

FIG. 5 is a cross sectional view of an alternative embodiment of the disclosure.

### DETAILED DESCRIPTION OF THE INVENTION

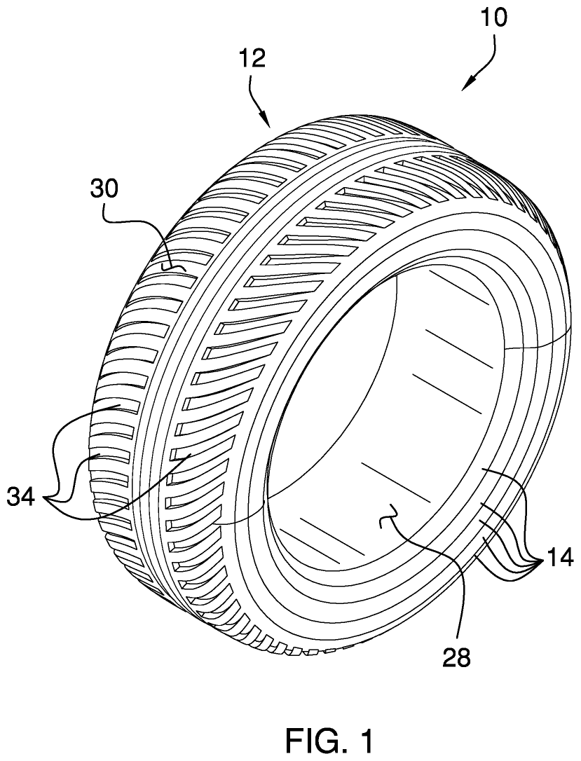

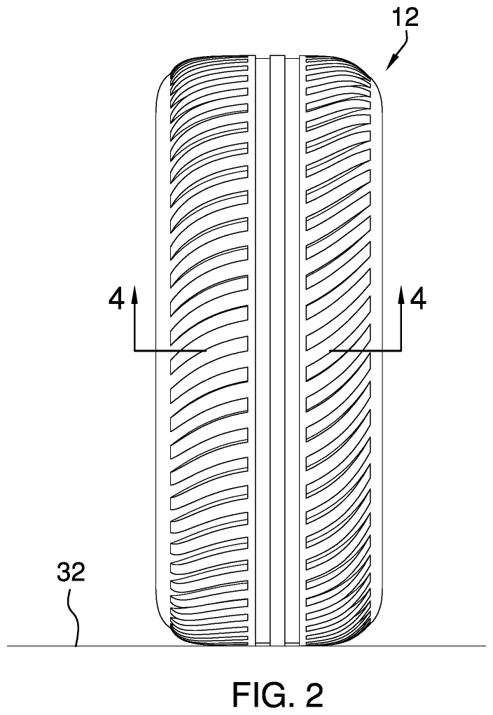

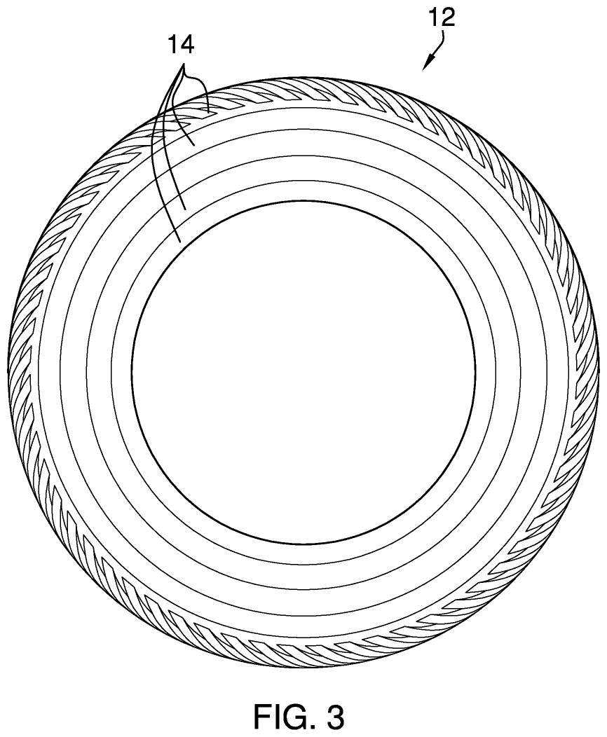

With reference now to the drawings, and in particular to FIGS. 1 through 5 thereof, a new solid tire device embodying the principles and concepts of an embodiment of the disclosure and generally designated by the reference numeral 10 will be described.

As best illustrated in FIGS. 1 through 5, the solid tire assembly 10 generally comprises a tire 12 that is defined by a plurality of concentric rings 14. Each of the concentric rings 14 is comprised of a resiliently compressible material to facilitate the tire 12 to perform similar to an inflated tire 12. Each of the concentric rings 14 is comprised of a plurality of bands 16 that each forms a closed loop. The bands are laid next to each other such that intersections 18 between the bands extend around a full circumference of the concentric rings. Moreover, intersections 18 between each of the bands 16 of each of the concentric rings 14 are staggered with respect to each of the concentric rings 14 to enhance structural integrity of the tire 12.

The plurality of concentric rings 14 includes an innermost ring 20, an outermost ring 22, a medial ring 24 and a pair of inner rings 26 each being positioned between the medial ring 24 and a respective one of the innermost ring 20 and the outermost ring 22. The innermost ring 20 has an exposed surface 28 that is directed toward a center point of the tire 12 and the outermost ring 22 has an outermost surface 30 that rolls along a support surface 32, such as a roadway or the like. Additionally, the outermost surface 30 has treads 34 integrated into the outermost surface 30 for enhancing traction of the tire 12.

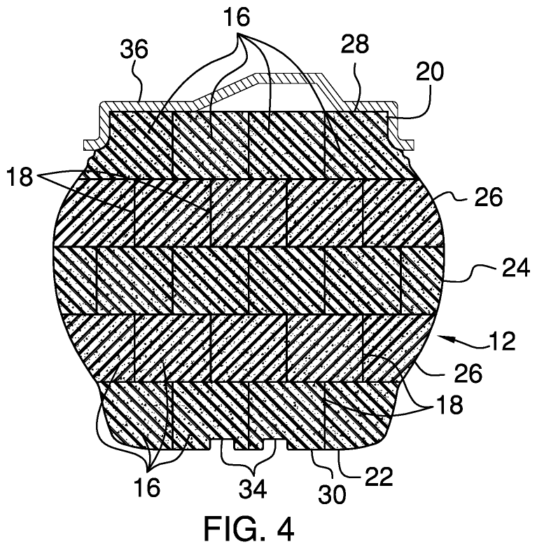

The medial ring 24 has a width that is greater than any of the concentric rings 14. Each of the innermost ring 20 and the outermost ring 22 has a width that is less than any of the concentric rings 14. Moreover, each of the inner rings 26 has a width that is between the width of the medial ring 24 and the width of the innermost ring 20 and the outermost ring 22. In this way, as is most clearly shown in FIG. 4, the concentric rings 14 give the tire 12 an ovoid cross section. The intersections 18 between each of bands 16 of the inner rings 26 are offset with respect to the intersections 18 between the bands 16 of the medial ring 24 and the bands 16 of the respective innermost ring 20 and the outermost ring 22. As is most clearly shown in FIG. 4, the tire 12 may be mounted to a rim 36 in the convention of traditional vehicle tires.

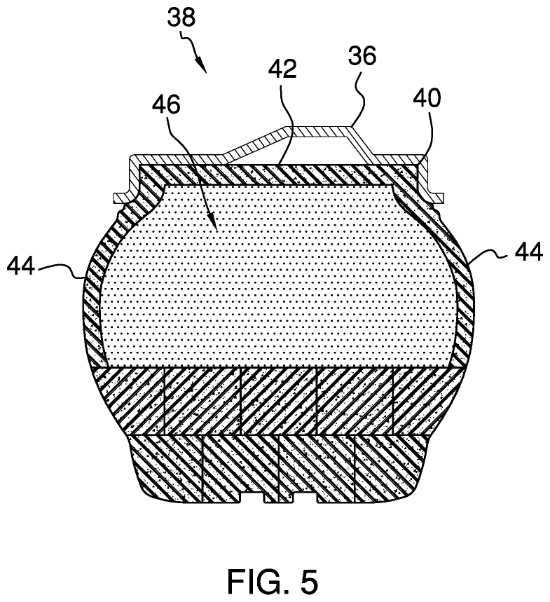

In an alternative embodiment 38 as is most clearly shown in FIG. 5, the tire 12 comprises a pair of concentric rings 14 and a skirt 40 that has an inner wall 42 and a pair of sidewalls 44. Each of the sidewalls 44 is coupled to a respective one of the concentric rings 14 such that the skirt 40 defines sidewalls and an inner surface of the tire 12. Moreover, the skirt 40 defines an air chamber 46 between the respective concentric ring 14 and the inner wall 42. The air chamber 46 is inflated with air thereby facilitating the air chamber 46 to cushion the ride of the tire 12.

In use, the innermost ring 20 is mounted to the rim 36 in the convention of a traditional vehicle tire. In this way the tire 12 can be mounted on a vehicle for the purposes of driving. The tire 12 can absorb nails, screws and other objects that would normally puncture an inflated tire. In this way the tire 12 eliminates the threat of a blowout or a flat tire while driving. Additionally, the resiliently compressible nature of each of the concentric rings 14 facilitates the tire 12 to simulate the ride of traditional inflated tires.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solid tire assembly for mounting on a vehicle thereby eliminating the threat of a blow out or flat tire, said assembly comprising:
a tire being defined by a plurality of concentric rings, each of said concentric rings being comprised of a resiliently compressible material wherein said plurality of concentric rings is configured to facilitate said tire to perform similar to an inflated tire, each of said concentric rings being comprised of a plurality of bands, intersections between each of said bands of each of said concentric rings being staggered with respect to each of said concentric rings to enhance structural integrity of said tire.

2. The assembly according to claim 1, wherein said plurality of concentric rings includes an innermost ring, an outermost ring, a medial ring and a pair of inner rings each being positioned between said medial ring and a respective one of said innermost ring and said outermost ring, said innermost ring having an exposed surface being directed toward a center point of said tire, said outermost ring having an outermost surface being configured to roll along a support surface, said outermost surface having treads being integrated into said outermost surface for enhancing traction of said tire.

3. The assembly according to claim 2, wherein said medial ring has a width being greater than any of said concentric rings.

4. The assembly according to claim 2, wherein each of said innermost ring and said outermost ring has a width being less than any of said concentric rings.

5. The assembly according to claim 2, wherein each of said inner rings has a width being between the width of said medial ring and the width of said innermost ring and said outermost ring.

6. The assembly according to claim 2, wherein said intersections between each of bands of said inner rings being offset with respect to said intersections between said bands of said medial ring and said bands of said respective innermost ring and said outermost ring.

7. A solid tire assembly for mounting on a vehicle thereby eliminating the threat of a blow out or flat tire, said assembly comprising:
a tire being defined by a plurality of concentric rings, each of said concentric rings being comprised of a resiliently compressible material wherein said plurality of concentric rings is configured to facilitate said tire to perform similar to an inflated tire, each of said concentric rings being comprised of a plurality of bands, intersections between each of said bands of each of said concentric rings being staggered with respect to each of said concentric rings to enhance structural integrity of said tire, said plurality of concentric rings including an innermost ring, an outermost ring, a medial ring and a pair of inner rings each being positioned between said medial ring and a respective one of said innermost ring and said outermost ring, said innermost ring having an exposed surface being directed toward a center point of said tire, said outermost ring having an outermost surface being configured to roll along a support surface, said outermost surface having treads being integrated into said outermost surface for enhancing traction of said tire, said medial ring having a width being greater than any of said concentric rings, each of said innermost ring and said outermost ring having a width being less than any of said concentric rings, each of said inner rings having a width being between the width of said medial ring and the width of said innermost ring and said outermost ring, said intersections between each of bands of said inner rings being offset with respect to said intersections between said bands of said medial ring and said bands of said respective innermost ring and said outermost ring.

8. The assembly according to claim 7, wherein said tire comprises a pair of concentric rings and a skirt having an inner wall and a pair of sidewalls each being coupled to a respective one of said concentric rings such that said shirt defines sidewalls and an inner surface of said tire, said skirt defining an air chamber between said respective concentric ring and said inner wall, said air chamber being inflated with air wherein said air chamber is configured to cushion the ride of said tire.
